(19) United States
(12) Patent Application Publication
(10) Pub. No.: US 2024/0197440 A1
(43) Pub. Date: Jun. 20, 2024

(54) SYSTEM AND METHOD FOR TREATMENT OF A CANINE'S TEETH

(71) Applicant: Black Tulip Management, Inc., Johns Island, SC (US)

(72) Inventors: Michael Nickels, St. Louis, MO (US); Henry Crossetti, Johns Island, SC (US)

(21) Appl. No.: 18/539,016

(22) Filed: Dec. 13, 2023

Related U.S. Application Data
(60) Provisional application No. 63/432,506, filed on Dec. 14, 2022.

(51) Int. Cl. A61C 3/00

(52) U.S. Cl. CPC A61C 3/005

(57) ABSTRACT

A system and method for treating the gums and teeth of a canine. The system and method comprising a finger applicator device and a gel solution to prevent tooth decay and gum diseases. The system and method further comprising DNA analysis to determine the risk of oral infection and treatment protocol.

### RELATED APPLICATION AND INCORPORATION BY REFERENCE

This application claims benefit of and priority to U.S. Provisional Patent Application Ser. No. 63/432,506, filed Dec. 14, 2022. The foregoing application is hereby incorporated by reference.

### FIELD OF DISCLOSURE

The present disclosure generally relates to a system and method for treatment of the teeth and gums of a canine or other animal.

### BACKGROUND

Canines (and other animals) have a high risk of plaque formation on the gums and teeth. Excessive plaque buildup often leads to gingivitis, periodontitis, calculus, tooth decay and bad breath.

Periodontal disease is the most common infection in the canine world, with 90% of all canines demonstrating periodontal disease by age three.

In canines, periodontal disease starts on the front surface of the teeth (in contrast to humans). Differences in periodontal disease between humans and canines may be attributed to the differing swallowing patterns. Contrary to humans, the tongue movement in canines is limited to front and back movement, thus putting pressure on the back surfaces of teeth which results in natural plaque removal from the back surfaces of the teeth. However, canines are unable to use their tongues to apply the same pressure to the front surfaces of teeth. This results in failure to eliminate excess plaque buildup on the front surfaces of teeth and can lead to serious health risks.

Under current practice, removal of the excess plaque may require tooth removal or teeth-cleaning under general anesthesia. Placing a canine (or other pet) under anesthesia can lead to further complications such as arrhythmia, tachycardia, organ failure, blindness and, in some cases, death.

In humans, daily tooth brushing has long been a preferred approach for maintenance of teeth and gums. However, only the most docile animals are capable of cooperating with this traditional approach. Canines in particular require extensive training for traditional brushing and flossing to be effective as most canines consider the process of tooth brushing invasive.

A long felt, but unmet, need exists for a simple nonintrusive system and method to treat the gums and teeth of a canine.

### SUMMARY OF DISCLOSURE

This summary is provided to introduce a selection of concepts in a simplified form further described in the detailed description of the disclosure. This summary is not intended to identify key or essential inventive concepts of the claimed subject matter, nor is it intended for determining the scope of the claimed subject matter.

The object of the present invention is to provide a system and method for treating the gums and teeth of a canine (or other animal) to overcome the disadvantages of traditional brushing and flossing.

According to the present invention, this objective is achieved by daily application of an antimicrobial gel with an applicator device to the gums of the canine (or other animal). The applicator may be in the form of a toothbrush or may be in the form of other devices such as a finger applicator.

In addition, the system and method may comprise the steps of analyzing saliva of the canine to determine a risk assessment of periodontal disease (or other oral health risks) and establishing a treatment protocol.

Embodiments of the present disclosure address one or more of the disadvantages and problems discussed above.

### BRIEF DESCRIPTION OF DRAWINGS

FIG. 1 depicts a front view of a finger applicator for use in treating a canine's teeth and gums.

FIG. 2 depicts a perspective view of the finger applicator in FIG. 1.

FIG. 3 depicts the finger applicator in FIG. 1 being attached to the finger of a user.

FIG. 4 depicts the finger applicator of FIG. 1 on the index finger of a user.

FIG. 5 depicts a front view of an alternative applicator for use in treating a canine's teeth and gums.

FIG. 6 depicts a perspective view of the applicator in FIG. 5.

FIG. 7 depicts the front side of the head of the applicator of FIG. 5.

FIGS. 8A and 8B depict the jaw and gum line of a canine.

FIGS. 9A and 9B depict containers of the gel solution for use in treating a canine's teeth and gums.

FIG. 10 depicts the method of applying gel solution to a canine's teeth and gums.

FIG. 11 depicts a flow chart regarding the steps for treating a canine's teeth and gums.

### DETAILED DESCRIPTION

This disclosure as a whole may be best understood by reference to the following detailed description when read in conjunction with the accompanying drawings, descriptions, abstract, background, field of disclosure and associated headings. Identical reference numbers when found on different drawings identify the same elements or a functionally equivalent element. The elements listed in the abstract are not referenced but nevertheless refer by association to the elements of the detailed description and associated disclosure.

This disclosure relates to a system for treating the gums and teeth of a canine 800 (or animal) comprising a finger applicator 100 and gel solution 200. The method for treatment includes the application of the gel solution 200 to the gums and teeth of the canine 800 (or other animal) to remove and/or prevent growth of bacteria. The method for treatment may further comprise repeated collection and testing of a canine's (or other animal) saliva 302, 304, 310, 312 and development of a treatment protocol 306, 314, 316, 318.

### Finger Applicator

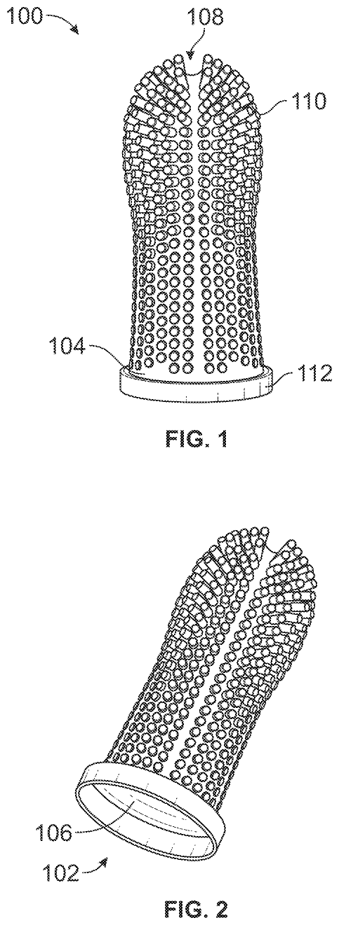

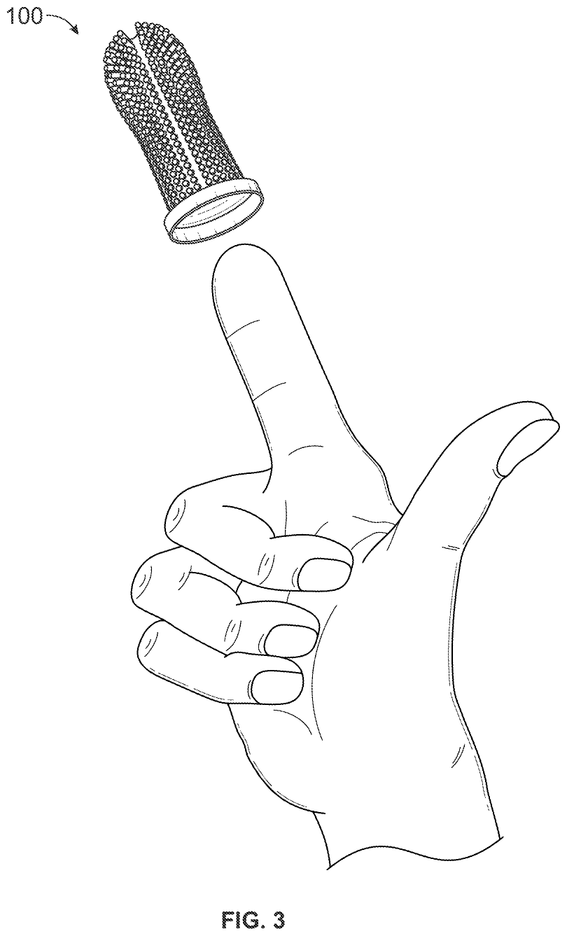

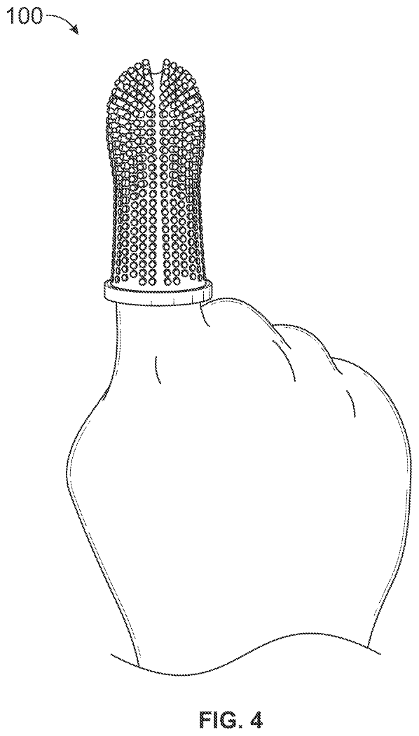

As shown in FIGS. 1-4, the finger applicator 100 is intended to be placed over one or more fingers of a user for use as a dental cleaning device. The finger applicator 100 is a tubular structure comprised of an outer wall 104 and having a first, closed end 108 and a second, open end 102. The outer wall 104 comprises an outer surface and an interior surface. The space between the interior surface of the outer wall 104 and the opening 102 define a cavity 106. The cavity 106 is shaped to allow a user to insert their finger(s) into the cavity 106 and “wear” the finger applicator 100.

In the embodiment shown in FIGS. 1-4, the outer surface of the outer wall 104 comprises a texture 110, wherein the texture 110 is formed from raised portions extending from the outer surface of the outer wall 104 of the finger applicator 100. In the embodiment shown in FIGS. 1-4, the texture 110 is approximately uniformly distributed across the entirety of the outer wall 104 of the finger applicator 100.

In an embodiment of the present disclosure, the raised portions of the texture 110 are string-like in shape and are substantially uniform in length and dimensions.

In an alternative embodiment, the raised portions of the texture 110 are string-like in shape but are not substantially uniform in length and dimensions. In another alternative embodiment, the raised portions of the texture 110 may comprise a plurality of dimples which are substantially uniformly distributed across the outer wall 104 of the finger applicator 100. In another alternative embodiment, the raised portions of the texture 110 comprise a plurality of dimples which are only located proximate the closed end 108 of the applicator 100, leaving a smooth outer surface of the outer wall 104 proximate the constricting band 112 of the finger applicator 100. In another alternative embodiment, the raised portions of the texture 110 are distributed proximate the closed end 108 and along less than half of the outer wall 104, leaving a smooth portion along greater than half of the outer wall 104. In another alternative embodiment, the outer wall 104 of the finger applicator 100 is comprised of an entirely smooth outer surface. Further alternative embodiments may comprise combinations of the above identified embodiments or may comprise other embodiments of finger applicators 100 known to one of skill in the art.

In the embodiment shown in FIGS. 1-4, a constricting band 112 is attached to the finger applicator 100 proximate the opening 102. The constricting band 112 is integrally formed from the edges of the outer wall 104 of the finger applicator 100. The interior portion of the constricting band 112 is flush with the interior wall of the finger applicator 100 and the exterior portion of the constricting band 112 protrudes in a generally perpendicular direction from the outer wall 104 of the finger applicator 100. The constricting band 112 forms a seal around a user's finger during the intended use of the finger applicator 100.

In the embodiment of FIGS. 1-4, the finger applicator 100 is comprised of a substantially waterproof material. The finger applicator 100 and texture 110 may be comprised of rubber, latex, non-latex or another suitable soft, elastic material.

The finger applicator 100 is used to apply a gel solution 200 (defined below) to a canine's (or another animal's) teeth and massage the canine's (or another animal's) gums.

### Alternative Applicators

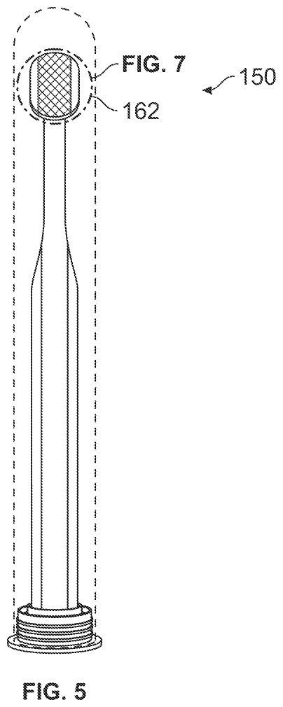

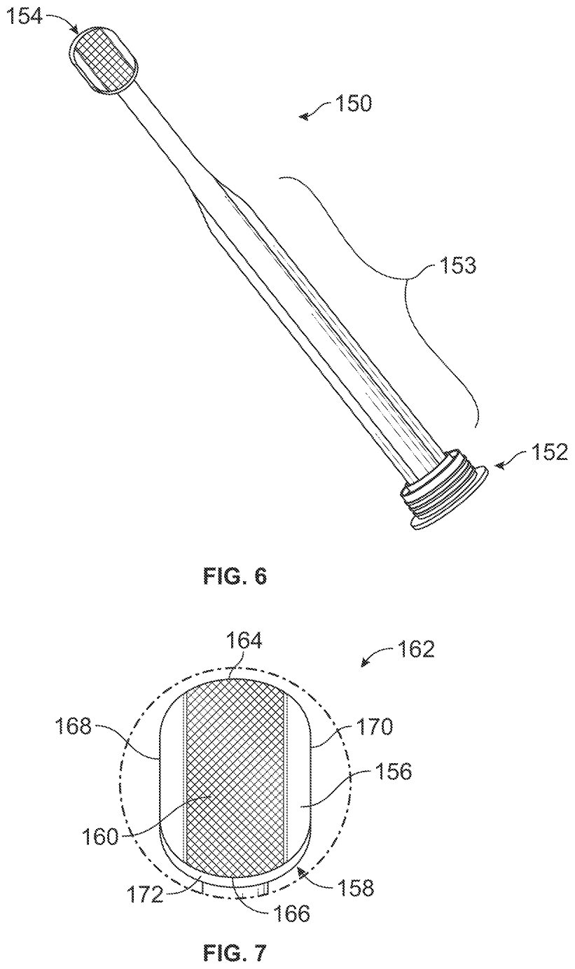

Alternative applicators may be used instead of the finger applicator 100. As shown in FIGS. 5-7, an applicator 150 may generally take the form of a toothbrush. The applicator 150 is comprised of a first end 152, comprising a handle 153 for the user, and a second end 154, comprising a head 162 to apply the gel solution 200 to an animal's teeth and massage the animal's gums. The head 162 of the applicator 150 comprises a face 156 and a back side 158. The head 162 further comprises a top side 164, bottom side 166, left side 168 and right side 170, with a thickness 172 between the face 156 and back side 158. In the preferred embodiment depicted in FIGS. 5-7, the head of applicator 150 forms a rectangular shape with a rounded top side 164 and bottom side 166, wherein the distance between the left 168 and right sides 170 is shorter in length than the lengths of the top side 164 and bottom side 166.

In the embodiment depicted in FIGS. 5-7, the face 156 comprises a texture 160, wherein the texture 160 is formed from raised portions protruding from the face 156 of the applicator 150. The handle of the applicator 153 is comprised of a solid material such as plastic or the like. The texture 160 is comprised of rubber, latex, non-latex or any other suitable soft, elastic material for use in massaging the gums of a canine.

In the embodiment depicted in FIGS. 5-7, the texture 160 extends along the full height of the face 156 from the top side 164 of the head to the bottom side 166 of the head 162, but does not extend the full width of the face 156 from the left side 168 to the right side 170.

In an alternative embodiment, the texture 160 forms the surface of the entirety of the face 156 of the head 162. In another alternative embodiment, the texture 160 forms less than the surface of the entirety of the face 156 of the head 162. In such alternative embodiment, the outer boundary of the texture 160 may be arranged in a circular, triangular, quadrilateral, tetrahedral, hexagonal, or other similar shape.

In the preferred embodiment of the present disclosure, the raised portions of the texture 160 comprise a plurality of dimples which are substantially uniformly distributed across the texture 160.

In an alternative embodiment of the present disclosure, the raised portions of the texture 160 are string-like in shape and are substantially uniform in length and dimensions. In another alternative embodiment, the raised portions of the texture 160 are string-like in shape but are not substantially uniform in length and dimensions. In another alternative embodiment, the head 162 of the applicator 150 is comprised of an entirely smooth, soft rubber surface outer surface. Further alternative embodiments may comprise combinations of the above identified embodiments or may comprise other embodiments of other applicators 150 known to one of skill in the art.

### Gel Solution

A gel solution 200 is intended to be placed on the finger applicator(s) 100, 150 for use in treating the gums and teeth of a canine 800 (or other animal). The gel solution 200 comprises an antimicrobial gel capable of destroying (ad/or preventing growth of) the bacteria responsible for gum diseases in canines (or other animals).

In the preferred embodiment, the gel solution 200 is an halogen-based antimicrobial gel solution 200 further comprising a mixture of water purification compounds and hydrating compounds to improve the health of the gums of a canine or other animal.

The gel solution 200 is non-toxic and does not absorb into the gum tissue and is safe for application in canines and other animals of all sizes. The gel solution 200 is not an antibiotic and therefore does not contribute to the creation of resistant strains of bacteria. Effectiveness of the gel solution 200 does not require digestion or consumption. The gel solution 200 eliminates bacteria on contact. The gel solution 200 does not have any dosage limitation, as the solution itself 200 does not penetrate the membrane of the canine's gums. Further, canines have difficulty swallowing the gel solution 200 as long as it is applied to the outer side of the canine's teeth.

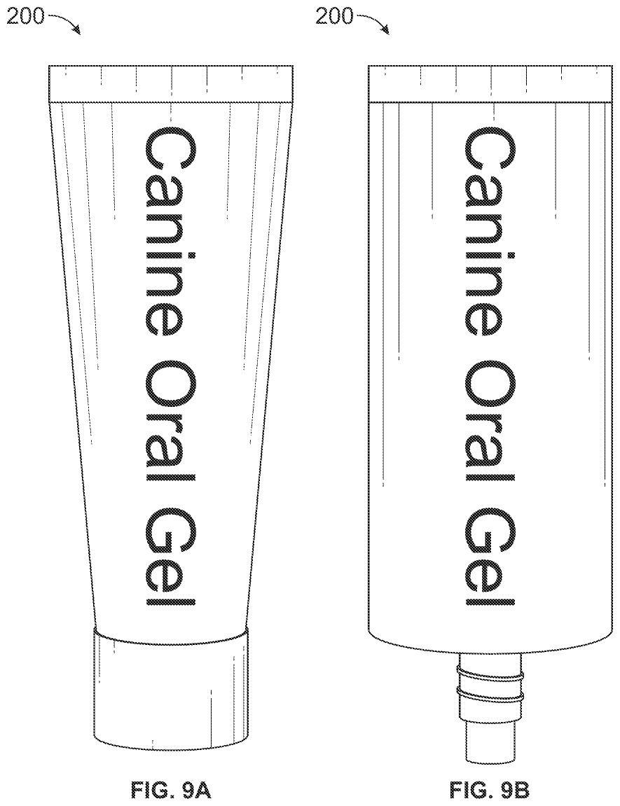

As shown in FIGS. 9A and 9B, the gel solution 200 is stored in a container with or without a pump. In the preferred embodiment, the gel solution 200 is dispensed from an airless pump to avoid recontamination. In alternative embodiments, any other dispensing device known in the art may be used to dispense the gel solution 200.

In an embodiment, the gel solution 200 is comprised of a combination of one or more of the following components: a water soluble polymer (such as Carbopol® 974), sodium chlorite, hyaluronate, mint oil, sucralose, sodium hydroxide, glycerin, and deionized water. In another embodiment, the gel solution 200 is further comprised of sodium hypochlorite.

In an illustrative embodiment, a water soluble polymer comprises between 0 to 2% by weight of the gel solution 200, sodium chlorite comprises about 0 to 0.5% by weight of the gel solution 200, hyaluronate comprises about 0 to 0.5% of the gel solution 200, mint oil comprises about 0 to 0.5% by weight of the gel solution 200, sucralose comprises about 0 to 0.5% by weight of the gel solution 200, sodium hydroxide comprises about 0 to 0.5% by weight of the gel solution 200, glycerin comprises about 0 to 1% by weight of the gel solution 200, deionized water comprises about 95 to 99% by weight of the gel solution 200, and sodium hypochlorite comprises about 0 to 0.5% by weight of the gel solution 200.

In the preferred embodiment, Carbopol 974 ® comprises approximately 1% by weight of the gel solution 200, sodium chlorite comprises approximately 0.058% by weight of the gel solution 200, hyaluronate comprises approximately 0.01% by weight of the gel solution 200, mint oil comprises approximately 0.0136% by weight of the gel solution 200, sucralose comprises approximately 0.04% by weight of the gel solution 200, the sodium hydroxide comprises approximately 0.09% by weight of the gel solution 200, the glycerin comprises approximately 0.63% by weight of the gel solution 200, and the deionized water comprises approximately 98.14% to 98.16% by weight of the gel solution 200.

In compositions which include sodium hypochlorite, the sodium hypochlorite may comprise approximately 0.008% by weight of the gel solution 200.

### Method of Treatment

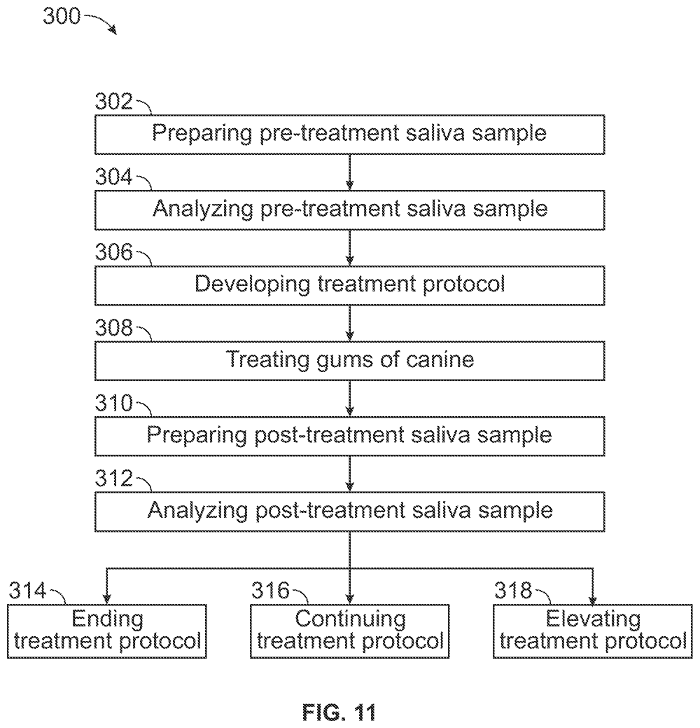

The method of use of the system 300 is shown in FIG. 11. The method comprises the steps of preparing a pre-treatment saliva sample 302, analyzing a pre-treatment saliva sample 304, developing a treatment protocol 306, treating the gums of the canine 308, preparing a post-treatment saliva sample 310, analyzing the post-treatment saliva sample 312, and (i) ending the treatment protocol 314, (ii) continuing the treatment protocol 316, or (iii) elevating the treatment protocol 318.

### Preparing and Analyzing Pre-Treatment Saliva Sample

A saliva sample is taken from the canine 302 by swabbing along the canine's teeth and gums, placing the swab in a preservative, and sending the swab to a lab for DNA analysis 304 of the bacteria. The swab is tested for the concentration of bacteria. The concentration of bacteria and bacteria type provide the basis for risk assessment analysis 304 of the canine's oral health. The risk assessment for the canine is broken down in three categories: mild risk, moderate risk, or high risk. Risk assessment evaluations are further described in the examples of treatment effectiveness below and in Tables 1, 2, and 3.

### Developing Treatment Protocol

A treatment protocol 306 is established based on the risk assessment of the canine. The protocol for low risk canines is treatment with the gel solution 200 once per day for at least 21 days. The protocol for moderate risk canines is treatment with the gel solution 200 once or twice per day for at least 21 days. The protocol for high risk canines is treatment with the gel solution 200 twice per day for at least 21 days. In an alternative embodiment, the canine is treated for a time period of 30 days.

### Treating Gums of Canine

The gums and teeth of the canine are treated 308 by applying the gel solution 200 with the applicator(s) 100, 150. First, a user places the finger applicator 100 on the dominant index finger of the user. Second, the user places the finger applicator 100 into the gel solution 200 (or alternatively places the gel solution 200 on the applicator 100). Third, the user applies the gel solution 200 to the gums of the canine, working from the back of the canine's mouth toward the front.

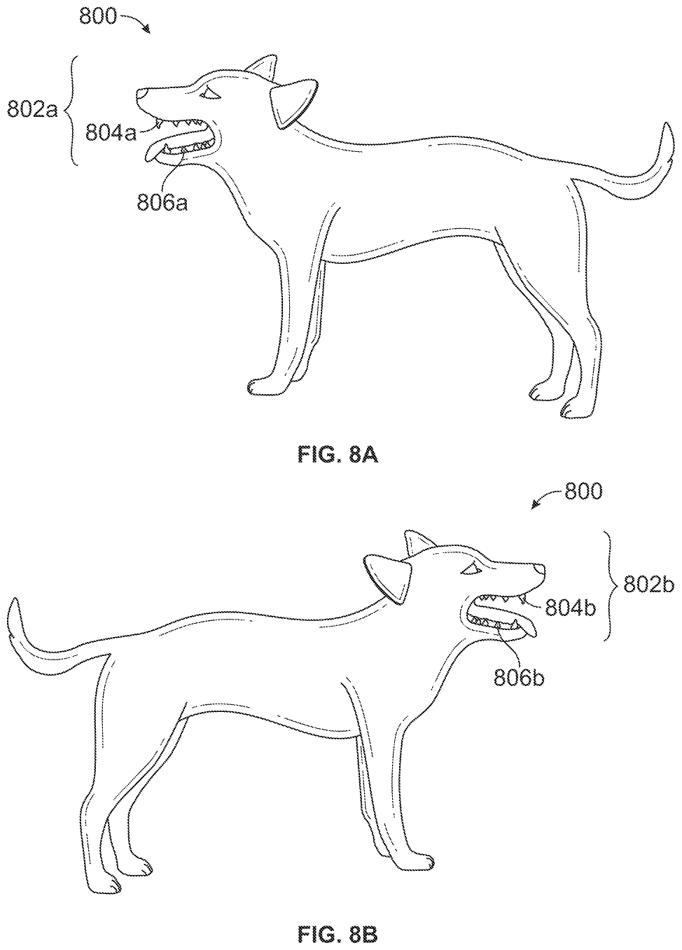

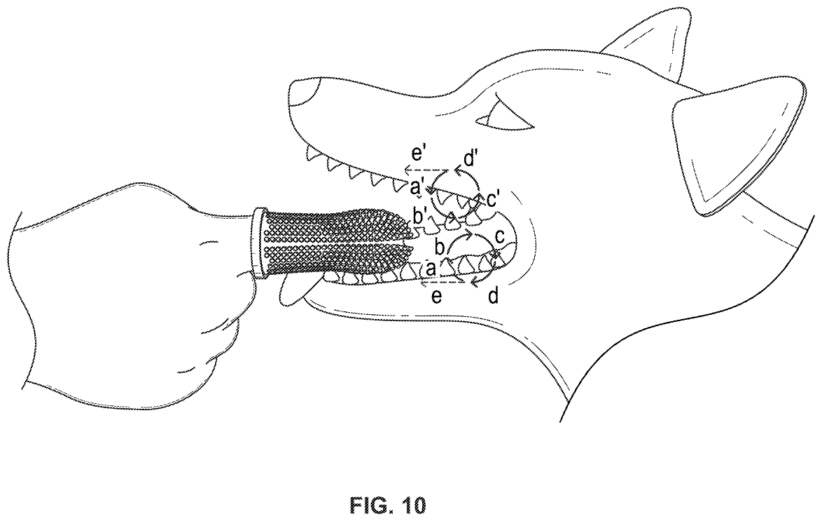

FIG. 8 depicts a canine's head 800, both sides of the canine's face 802a, 802b, and the canine's upper 804a, 804b and lower 806a, 806b jaws. The preferred method of applying the gel solution 200 to the canine 800 (i.e., “Treating gums of canine” 308) is depicted in FIG. 10. The preferred method of treating the gums of a canine 308 is described below.

In the preferred method, the user first lifts the top lip of the canine on a first side of the canine's face 802a. Next, the user places the finger applicator 100 (with the gel solution 200) at the gum line of the furthest back tooth of the first side of the canine's upper jaw 804a. The user applies the gel solution 200 to the tooth using a circular motion comprising a rotation which (a′) starts from the gum line and moves slightly downward and in the direction of the next tooth (towards the front of the canine's mouth), (b′) moves to the top of the tooth being cleaned (i.e., the pointed end of the tooth furthest from the gums), (c′) projects slightly upward and toward the back edge of the tooth being cleaned (away from the front of the mouth), and (d′) finally back to the gum line of the tooth being cleaned. Steps (a′) through (d′) comprise an “Upper Rotation.” A user must complete at least one Upper Rotation to clean a tooth before moving to the next tooth. Once a user completes at least one Upper Rotation, the user may (e′) move the finger applicator 100 from the gum line of the cleaned tooth to the gum line of the next tooth. The above-disclosed method continues until all of the teeth on the first side 802a of the canine's upper jaw 804a are cleaned.

Next, the user applies the same method to the second side 802b of the canine's upper jaw 804b. Prior to applying the gel solution 200 to the teeth of the second side 802b of the canine's upper jaw 804b, the user may remove the finger applicator 100 from the user's finger and move the finger applicator 100 to another of the user's fingers for ease of use. For example, a user may place the finger applicator 100 on the index finger of the user's right hand to clean the canine's upper jaw 804a on the first side 802a and then place the applicator 100 on the index finger of the user's left hand to clean the canine's upper jaw 804b on the second side 802b. In other embodiments, the user may use the finger applicator on any of the user's fingers.

Once the gel solution 200 has been applied to all of the teeth of the canine's upper jaw 804a, 804b, the user can move on to the bottom jaw 806a, 806b.

To apply the gel solution 200 to the bottom jaw 806a, 806b, the user first lifts the top lip of the canine (and if necessary, the bottom lip of the canine) on the first side 802a of the canine's face. Next, the user places the finger applicator 100 (with the gel solution 200) at the gum line of the furthest back tooth of the first side 802a of the canine's lower jaw 806b. The user applies the gel solution 200 to the tooth using a circular motion comprising a rotation which (a) starts from the gum line of the tooth and moves slightly upward and in the direction of the next tooth (towards the front of the canine's mouth), (b) moves to the top of the tooth (i.e., the pointed end of the tooth furthest from the gums) being cleaned, (c) projects slightly downward and toward the back edge of the tooth being cleaned, and (d) finally back to the gum line of the tooth being cleaned (away from the front of the mouth). Steps (a) through (d) comprise a “Lower Rotation.” A user must complete at least one Lower Rotation to clean a tooth before moving to the next tooth. Once a user completes at least one Lower Rotation, the user may (e) move the finger applicator 100 from the gum line of the cleaned tooth to the gum line of the next tooth. The above-disclosed method continues until the gel solution 200 has been applied to all of the teeth on the first side 802a of the canine's lower jaw 806a.

Next, the user applies the same method to the second side 802b of the canine's lower jaw 806b. Prior to applying the gel solution 200 to the teeth of the second side 802b of the canine's lower jaw 806b, the user may remove the finger applicator 100 from the user's finger and move the finger applicator 100 to another of the user's fingers for ease of use. For example, a user may place the finger applicator 100 on the index finger of the user's right hand to clean the canine's lower jaw 806a on the first side 802a and then place the applicator 100 on the index finger of the user's left hand to clean the canine's lower jaw 806b on the second side 802b. In other embodiments, the user may use the finger applicator 100 on any of the user's fingers.

Once the gel solution 200 has been applied to all of the teeth of the canine's lower jaw 806a, 806b and upper jaw 804a, 804b, the user has completed a single treatment.

If the treatment protocol 306 requires further treatments, the user may conduct a second treatment following the same process outlined above between 2-8 hours after the first treatment.

For the first (and second treatment, if applicable), the user applies the gel solution 200 in connection with the above described treatment method 308. During application of the gel solution 200 via the treatment method 308, the texture 110 of the finger applicator 100 massages the gums of the canine. After the treatment method 308 is completed, the user prevents the canine from ingesting any food or water for at least one hour. Placement of the gel solution 200 at the gum line and outward facing portion of the canine's teeth reduces the risk of the canine removing the gel solution 200.

In alternative embodiment of the present disclosure, different methods of applying the gel solution 200 to the canine's teeth and gums 308 are considered, including different arrangements of the order of the above identified steps and alternative methods to apply the gel solution 200 to the canine's teeth and gums.

For instance, a user may apply the gel solution 200 to the canine's teeth and gums 308 using alternative motions, such as a linear (back and forth) motion or a zig zag motion (starting at the top of the tooth and ending at the bottom of the tooth or vice versa).

Further, a user may elect to apply the gel solution 200 to the teeth and gums of the canine 308 in an alternate order. For instance, a user may begin applying the gel solution 200 to either of the first side 802a (either upper 804a or lower 806a jaw) or second side 802b (either upper 804b or lower 806b jaw) of the canine and proceed with any move on to the next portion of the canine's jaw 804a, 804b, 806a, 806b in any order.

In another alternative embodiment, a user may elect to apply the gel solution 200 to the teeth and gums of the canine 308 starting with the front teeth and moving toward the back teeth.

In an alternative method of treating the teeth and gums of the canine 308, the user may elect to apply a single Upper Rotation to each tooth of the canine's upper jaw 804a, 804b and/or a single Lower Rotation to each tooth of the canine's lower jaw 806a, 806b. In another alternative method of treating the teeth and gums of the canine 308, the user may elect to apply more than one Upper Rotation to each tooth of the canine's upper jaw 804a, 804b and/or more that one Lower Rotation to each tooth of the canine's lower jaw 806a, 806b.

In alternative embodiments, the above treatment 308 may be conducted with an alternative applicator 150 or with the user's finger (without the finger applicator 100). In the embodiment of the present disclosure, the user may begin the treatment 308 with any of the same methods described above, except that the user uses an alternative applicator 150 (or the user's finger) instead of the finger applicator 100.

### Preparing and Analyzing Post-Treatment Saliva Sample

A post-treatment saliva sample is taken from the canine 310 by swabbing along the canine's teeth and gums, placing the swab in a preservative, and sending the swab to a lab for post-treatment DNA analysis of the bacteria 312.

The swab is tested for the concentration of bacteria. The concentration of bacteria provides the basis for risk assessment analysis 312 of the canine's oral health. The risk assessment for the canine is broken down in three categories: low risk, moderate risk, or high risk.

### Ending, Continuing, or Elevating Treatment Protocol

Depending on the risk assessment, the protocol for treatment may be ended 314, continued with the same treatment protocol 316, or continued with an elevated treatment protocol 318. If the post-treatment risk assessment is low, the treatment protocol may be ended 314 or continued 316 with a once daily treatment for an additional 21-30 days. If the post-treatment risk assessment is moderate, the treatment protocol may be continued at the current daily treatment protocol for an additional 21-30 days. If the post-treatment risk assessment is high, the treatment protocol may be elevated 318 to once, twice, or more daily treatments for an additional 21-30 days. Elevated treatment protocol 318 may continue until the risk assessment is reduced to moderate or low.

As an alternative treatment method, a user may treat their pet's teeth and gums 308 daily (or twice daily) for any desired period of time.

### Examples of Treatment Effectiveness

Tables 1-3, depicted below, provide pre-treatment and post-treatment data for canines that have been treated in accordance with the present disclosure. In addition Tables 1-3 identify the treatment protocol for each canine based on assessed risk of bacteria and resulting effectiveness of treatment.

Individual pet names and ages are provided on the left side of Tables 1 and 2. Table 1 shows pre-treatment information regarding each of the identified pets. Table 2 shows post-treatment information regarding each of the identified pets. Table 3 shows a summary of the results of the treatment provided in accordance with the present disclosure.

The bacteria tested in Tables 1-3 is Porphyromonas gulae (P. gulae). P. gulae bacteria grows in all canines and oral hygiene requires maintaining the concentration of this bacteria at a low or limited level. Historically P. gulae is tested for multiple different strains of the bacteria (in this case, Type A, Type B, and Type C represent different strains of the P. gulae bacteria). Each of Type A, Type B, and Type C present differing levels of systemic risk to a canine (Type A is mild, Type B is High, and Type C is Severe). However, alternative tests may be run without segregating test results for Type A, Type B, or Type C P. gulae bacteria.

“Pg Normalized Load” reflects the concentration of P. gulae bacteria at the time the canine's saliva is tested. The concentration of bacteria is used to evaluate the severity of peridonal infection in canines. A technician evaluates the concentration of P. gulae bacteria to determine a “Risk Assessment” which is either low, moderate, or high. The technician accounts for the type of bacteria (i.e., Type A, Type B, and Type C, as well as the corresponding concentration and percentage of each of these bacteria strains present in the tested sample). In addition, the technician accounts for the age of the animal.

The risk assessment provides the basis for the treatment specifications for each animal. Where a technician determines that the risk assessment is low, the preferred treatment of the gums and teeth of the canine 308 is once daily for 21 days. Alternatively, treatment may be set for up to 30 days. Where a technician determines that the risk assessment is high, the preferred treatment of the gums and teeth of the canine 308 is twice daily for 21 days. Alternatively, treatment may be set for up to 30 days. In some cases, high risk canines may be treated 308 once daily upon recommendation from a veterinarian. Not shown is the treatment course for a moderate risk canine. Where a technician determines that the risk assessment is moderate, the preferred treatment of the gums and teeth of the canine 308 is once or twice daily for 21 to 30 days.

Table 2 shows the results of the proscribed treatments of Table 1. As shown, each animal risk assessment has either been kept constant at “Low” or has been reduced from “High” to “Low.” Also depicted are the resulting Pg normalized loads for each and every species of P. gulae bacteria. Including two columns showing the percent change in the composition of the remaining concentration of bacteria (i.e., Types A, B, and C) and the percent change in Pg normalized load pre- and post-treatment. Finally a results tab is shown on the right side of Table 2.

Table 3 depicts the overall results of the treatment in accordance with the disclosed method. Specifically, Table 3 identifies the average reduction of “Pg Normalized Load” for each of Type A, Type B, and Type C P. gulae bacteria.

Tables 1-3 show that the disclosed method of treatment prevents overgrowth of P. gulae bacteria and reverses the symptoms of periodontal disease when the method is used over at least a 21-day period. In older canines, the method will reverse the concentration of bacteria to the point that the canine will no longer have a risk of tooth infection. In younger canines, the method of treatment is preventative.

It is understood that the preceding is merely a detailed description of some examples and embodiments of the present disclosure and that numerous changes to the disclosed embodiments may be made in accordance with the disclosure made herein without departing from the spirit or scope of the disclosure. The preceding description, therefore, is not meant to limit the scope of the disclosure, but to provide sufficient disclosure to allow one of ordinary skill in the art to practice the disclosure without undue burden.

TABLE 1

| | | Pre-treatment Saliva Sample | | | | | Treatment Specs | |
|---|---|---|---|---|---|---|---|---|
| Pet Info | | Systemic | Pg | | Pg Normalized | Risk | Application | Length |
| Name | Age | Risk | fimA | Percentage | Load | Assessment | Frequency | of Study |
| George | 11 | Mild | Type A | 100.0% | 267.8 | High | Twice Daily | 21 Days |
| | | High | Type B | 0.0% | 0 | | | |
| | | Severe | Type C | 0.0% | 0 | | | |
| Penelope | 3 | Mild | Type A | 26.9% | 28.4 | High | Twice Daily | 21 Days |
| | | High | Type B | 0.1% | 0.1 | | | |
| | | Severe | Type C | 73.0% | 77.2 | | | |
| Aussie | 11 | Mild | Type A | 13.2% | 13 | High | Twice Daily | 28 Days |
| | | High | Type B | 0.0% | 0 | | | |
| | | Severe | Type C | 86.8% | 84.9 | | | |
| Tegyn | 11 | Mild | Type A | 100.0% | 15.7 | Low | Once Daily | 21 Days |
| | | High | Type B | 0.0% | 0 | | | |
| | | Severe | Type C | 0.0% | 0 | | | |
| Nollie | 5 | Mild | Type A | 91.3% | 158.2 | High | Once Daily | 21 Days |
| | | High | Type B | 0.0% | 0 | | | |
| | | Severe | Type C | 8.7% | 15 | | | |
| Lupa | 2 | Mild | Type A | 71.9% | 18 | Low | Once Daily | 21 Days |
| | | High | Type B | 0.0% | 0 | | | |
| | | Severe | Type C | 28.1% | 7 | | | |
| Lady | 11 | Mild | Type A | 26.0% | 29.3 | High | Once Daily | 21 Days |
| | | High | Type B | 0.0% | 0 | | | |
| | | Severe | Type C | 74.0% | 83.4 | | | |
| Mack | 7 | Mild | Type A | 90.6% | 228.2 | High | Once Daily | 21 Days |
| | | High | Type B | 0.0% | 0 | | | |
| | | Severe | Type C | 9.4% | 23.7 | | | |
| Bella | 1 | Mild | Type A | 53.1% | 27.7 | High | Twice Daily | 21 Days |
| | | High | Type B | 11.2% | 5.8 | | | |
| | | Severe | Type C | 35.7% | 18.6 | | | |
| Rosey | 5 | Mild | Type A | 93.1% | 62.7 | High | Twice Daily | 21 Days |
| | | High | Type B | 0.5% | 0.3 | | | |
| | | Severe | Type C | 6.4% | 4.3 | | | |
| Scarlett | 14 | Mild | Type A | 16.3% | 6.4 | High | Twice Daily | 21 Days |
| | | High | Type B | 5.0% | 2 | | | |
| | | Severe | Type C | 78.7% | 31.1 | | | |

TABLE 2

| | | Post-treatment Saliva Sample | | | | | Results | | |
|---|---|---|---|---|---|---|---|---|---|
| Pet Info | | Systemic | Pg | | Pg Normalized | Risk | | % Δ | |
| Name | Age | Risk | fimA | Percentage | Load | Assessment | Δ % | Pg Load | Summary |
| George | 11 | Mild | Type A | 100.0% | 25.6 | Low | 0.0% | 90.44% | Risk Assessment High → Low Type A |
| | | High | Type B | 0.0% | 0.0 | | — | — | load decreased by 90% |
| | | Severe | Type C | 0.0% | 0.0 | | — | — | |
| Penelope | 3 | Mild | Type A | 61.2% | 15.5 | Low | −34.3% | 45.42% | Risk Assessment High → Low Type A |
| | | High | Type B | 0.1% | 0.0 | | — | — | load decreased by 45% Type C load |
| | | Severe | Type C | 38.7% | 9.8 | | 34.3% | 87.31% | decreased by 87% |
| Aussie | 11 | Mild | Type A | 71.2% | 61.9 | Low | −58.0% | −376.15% | Risk Assessment High → Low Type A |
| | | High | Type B | 0.0% | 0.0 | | — | — | load increased by 376% Type C load |
| | | Severe | Type C | 28.8% | 25.0 | | 58.0% | 70.55% | reduced by 70% |
| Tegyn | 11 | Mild | Type A | 100.0% | 12.4 | Low | 0.0% | 21.02% | Risk Assessment Low → Low Type A |
| | | High | Type B | 0.0% | 0.0 | | — | — | load decreased by 21% |
| | | Severe | Type C | 0.0% | 0.0 | | — | — | |
| Nollie | 5 | Mild | Type A | 100.0% | 0.4 | Low | −8.7% | 99.75% | Risk Assessment High → Low |
| | | High | Type B | 0.0% | 0.0 | | — | — | Type A load decreased by 99% Type C |
| | | Severe | Type C | 0.0% | 0.0 | | 8.7% | 100.00% | load decreased by 100% |
| Lupa | 2 | Mild | Type A | 98.7% | 13.6 | Low | −26.8% | 24.44% | Risk Assessment Low → Low Type A |
| | | High | Type B | 0.0% | 0.0 | | — | — | load decreased by 24% |
| | | Severe | Type C | 1.3% | 0.2 | | 26.8% | 97.14% | Type C load decreased by 97% |
| Lady | 11 | Mild | Type A | 12.0% | 0.3 | Low | 14.0% | 98.98% | Risk Assessment High → Low Type A |
| | | High | Type B | 0.0% | 0.0 | | — | — | load decreased by 98% Type C load |
| | | Severe | Type C | 88.0% | 2.0 | | −14.0% | 97.60% | decreased by 97% |
| Mack | 7 | Mild | Type A | 98.9% | 5.1 | Low | −8.3% | 97.77% | Risk Assessment High → Low Type A |
| | | High | Type B | 0.0% | 0.0 | | — | — | load decreased by 97% Type C load |
| | | Severe | Type C | 1.1% | 0.1 | | 8.3% | 99.58% | decreased by 99% |
| Bella | 1 | Mild | Type A | 48.4% | 0.5 | Low | 4.7% | 98.19% | Risk Assessment High → Low Type A |
| | | High | Type B | 35.5% | 0.3 | | −24.3% | 94.83% | load decreased by 98% Type B load |
| | | Severe | Type C | 16.1% | 0.2 | | 19.6% | 98.92% | decreased by 94% |
| | | | | | | | | | Type C load decreased by 98% |
| Rosey | 5 | Mild | Type A | 44.5% | 22.8 | Low | 48.6% | 63.64% | Risk Assessment High → Low Type A |
| | | High | Type B | 53.1% | 27.2 | | −52.6% | −8966.67% | load decreased by 63% Type B load |
| | | Severe | Type C | 2.4% | 1.2 | | 4.0% | 72.09% | increased by 8966% |
| | | | | | | | | | Type C load decreased by 72% |
| Scarlett | 14 | Mild | Type A | 15.1% | 1.3 | Low | 1.2% | 79.69% | Risk Assessment High → Low Type A |
| | | High | Type B | 39.3% | 3.4 | | −34.3% | −70.00% | load decreased by 79% Type B load |
| | | Severe | Type C | 45.6% | 3.9 | | 33.1% | 87.46% | increased by 70% |
| | | | | | | | | | Type C load decreased by 87% |

TABLE 3
Results

| | | |
|---|---|---|
| Type A | 72% | Average Reduction of Pg |
| | | Normalized Load |
| Type B | 2% | Average Reduction of Pg |
| | | Normalized Load |
| Type C | 74% | Average Reduction of Pg |
| | | Normalized Load |

1. A method of applying oral treatment gel to a canine's gums comprising the steps of:
applying treatment gel to an applicator;
lifting the upper lip on a first side of the canine's mouth to grant visibility and access to the upper teeth and gums of the canine;
gently pressing the treatment gel at the gum line of the tooth furthest from the front of the canine's mouth;
moving the applicator in a circular and counterclockwise direction while maintaining gentle pressure on the canine's tooth, wherein the path of movement is an “Upper Rotation” comprising the following steps:
(a) starting from the gum line and moving slightly downward and in the direction of the next tooth towards the front of the canine's mouth,
(b) moving to the pointed end of the tooth being cleaned and away from the gum line,
(c) moving slightly upward and toward the back edge of the tooth being cleaned and away from the front of the mouth, and
(d) returning back to the gum line of the tooth being cleaned;
moving the applicator to the adjacent tooth in the direction of the front of the mouth;
continuing to apply the treatment gel, using the Upper Rotation, to each tooth on the first side of the canine's upper jaw;
stopping application of the treatment gel to the upper teeth of the first side of the canine's mouth after applying the gel to the upper front teeth of the canine;
lifting the upper lip on a second side of the canine's mouth to grant visibility and access to the upper teeth and gums of the canine;
gently pressing the applicator at the gum line of the tooth furthest from the front of the canine's mouth;
moving the applicator using the Upper Rotation to clean each tooth on the second side of the canine's upper jaw,
stopping application of the treatment gel to the upper teeth on the second side of the canine's mouth after applying the gel to the front upper teeth of the canine;

1. A method of applying oral treatment gel to a canine's gums comprising the steps of:
applying treatment gel to an applicator;
lifting the upper lip on a first side of the canine's mouth to grant visibility and access to the upper teeth and gums of the canine;
gently pressing the treatment gel at the gum line of the tooth furthest from the front of the canine's mouth;
moving the applicator in a circular and counterclockwise direction while maintaining gentle pressure on the canine's tooth, wherein the path of movement is an “Upper Rotation” comprising the following steps:
(a) starting from the gum line and moving slightly downward and in the direction of the next tooth towards the front of the canine's mouth,
(b) moving to the pointed end of the tooth being cleaned and away from the gum line,
(c) moving slightly upward and toward the back edge of the tooth being cleaned and away from the front of the mouth, and
(d) returning back to the gum line of the tooth being cleaned;
moving the applicator to the adjacent tooth in the direction of the front of the mouth;
continuing to apply the treatment gel, using the Upper Rotation, to each tooth on the first side of the canine's upper jaw;
stopping application of the treatment gel to the upper teeth of the first side of the canine's mouth after applying the gel to the upper front teeth of the canine;
lifting the upper lip on a second side of the canine's mouth to grant visibility and access to the upper teeth and gums of the canine;
gently pressing the applicator at the gum line of the tooth furthest from the front of the canine's mouth;
moving the applicator using the Upper Rotation to clean each tooth on the second side of the canine's upper jaw,
stopping application of the treatment gel to the upper teeth on the second side of the canine's mouth after applying the gel to the front upper teeth of the canine;
lifting the upper lip and on the first side of the canine's mouth to grant visibility and access to the lower teeth and gums of the canine;
gently pressing the treatment gel at the gum line of the tooth furthest from the front of the canine's mouth;
moving the applicator in a circular and counterclockwise direction while maintaining gentle pressure on the canine's tooth, wherein the path of movement is a “Lower Rotation” comprising the following steps:
(a) starting from the gum line and moving slightly upward and in the direction of the next tooth towards the front of the canine's mouth,
(b) moving to the pointed end of the tooth being cleaned and away from the gum line,
(c) moving slightly downward and toward the back edge of the tooth being cleaned and away from the front of the mouth, and
(d) returning back to the gum line of the tooth being cleaned;
moving the applicator to the adjacent tooth in the direction of the front of the mouth;
continuing to apply the treatment gel, using the Lower Rotation, to each tooth on the first side of the canine's lower jaw;
stopping application of the treatment gel to the lower teeth of the first side of the canine's mouth after applying the gel to the lower front teeth of the canine;
lifting the upper lip on a second side of the canine's mouth to grant visibility and access to the lower teeth and gums of the canine;
gently pressing the applicator at the gum line of the tooth furthest from the front of the canine's mouth;
moving the applicator using the Lower Rotation to clean each tooth on the second side of the canine's lower jaw;
stopping application of the treatment gel to the lower teeth on the second side of the canine's mouth after applying the gel to the front upper teeth of the canine; and
preventing the canine from ingesting any food or water for at least one hour after treatment.

2. The method of applying oral treatment gel to a canine's gums of claim 1, comprising the additional step of applying additional treatment gel to the applicator after each Upper Rotation and Lower Rotation is completed.

3. The method of claim 1, wherein the applicator is a finger applicator, and prior to applying the treatment gel to the applicator, the user places the finger applicator on the dominant finger of the user.

4. The method of claim 1, wherein the applicator is the user's dominant index finger.

5. The method of claim 1, wherein the applicator is an alternative applicator in the form of a toothbrush.

6. The method of claim 1, wherein the oral treatment gel is reapplied to a canine's gums after 2-8 hours using the same steps disclosed in claim 1.

7. The method of claim 1, wherein the oral treatment gel is applied once daily for twenty-one days.

8. The method of claim 1, wherein the oral treatment gel is applied twice daily for twenty-one days.

9. A method of cleaning and treating a canine's gums comprising the steps of:
performing a first swab of a canine's gum line and placing the swab in a preservative for DNA analysis;
analyzing the swab for bacteria;
developing a treatment protocol for the canine's gums;
applying treatment gel to the canine, the application of gel comprising the steps of:
placing a finger applicator on the dominant finger of the user;
applying treatment gel to the finger applicator;
applying the treatment gel to the outer surface of the canine's teeth and gums;
preventing canine from ingesting food or water for a one-hour period after treatment;
performing a second swab of a canine's gum line and placing the swab in a preservative for DNA analysis;
analyzing the second swab for bacteria; and
analyzing the effectiveness of the method.

10. The method of claim 9, wherein the step of developing a treatment protocol for the canine's gums comprises the steps of:
determining the concentration of bacteria in the first swab;
determining the systemic risk to the canine's gums based, the systemic risk corresponding directly to the type of bacteria present in the first swab and consisting of either a mild, high, or severe risk; and
determining a risk assessment based on the systemic risk and concentration of bacteria in the first swab, wherein the risk assessment is either a high risk or low risk.

11. The method of claim 10, wherein the user proposes application of the gel solution to the canine once daily for 21 days if the risk assessment is a low risk.

12. The method of claim 10, wherein the user proposes application of the gel solution to the canine twice daily for 21 days if the risk assessment if a high risk.

13. The method of claim 9, wherein the step of applying the treatment gel to the outer surface of the canine's teeth and gums comprises the steps of:
lifting the upper lip on a first side of the canine's mouth to grant visibility and access to the upper teeth and gums of the canine;
gently pressing the treatment gel at the gum line of the tooth furthest from the front of the canine's mouth;
moving the applicator in a circular and counterclockwise direction while maintaining gentle pressure on the canine's tooth, wherein the path of movement is an “Upper Rotation” comprising the following steps:
(a) starting from the gum line and moving slightly downward and in the direction of the next tooth towards the front of the canine's mouth,
(b) moving to the pointed end of the tooth being cleaned and away from the gum line,
(c) moving slightly upward and toward the back edge of the tooth being cleaned and away from the front of the mouth, and
(d) returning back to the gum line of the tooth being cleaned;
moving the applicator to the adjacent tooth in the direction of the front of the mouth;
continuing to apply the treatment gel, using the Upper Rotation, to each tooth on the first side of the canine's upper jaw;
stopping application of the treatment gel to the upper teeth of the first side of the canine's mouth after applying the gel to the upper front teeth of the canine;
lifting the upper lip on a second side of the canine's mouth to grant visibility and access to the upper teeth and gums of the canine;
gently pressing the applicator at the gum line of the tooth furthest from the front of the canine's mouth;
moving the applicator using the Upper Rotation to clean each tooth on the second side of the canine's upper jaw;
stopping application of the treatment gel to the upper teeth on the second side of the canine's mouth after applying the gel to the front upper teeth of the canine;
lifting the upper lip and on the first side of the canine's mouth to grant visibility and access to the lower teeth and gums of the canine;
gently pressing the treatment gel at the gum line of the tooth furthest from the front of the canine's mouth;
moving the applicator in a circular and counterclockwise direction while maintaining gentle pressure on the canine's tooth, wherein the path of movement is a “Lower Rotation” comprising the following steps:
(a) starting from the gum line and moving slightly upward and in the direction of the next tooth towards the front of the canine's mouth,
(b) moving to the pointed end of the tooth being cleaned and away from the gum line,
(c) moving slightly downward and toward the back edge of the tooth being cleaned and away from the front of the mouth, and
(d) returning back to the gum line of the tooth being cleaned;
moving the applicator to the adjacent tooth in the direction of the front of the mouth;
continuing to apply the treatment gel, using the Lower Rotation, to each tooth on the first side of the canine's lower jaw;
stopping application of the treatment gel to the lower teeth of the first side of the canine's mouth after applying the gel to the lower front teeth of the canine;
lifting the upper lip on a second side of the canine's mouth to grant visibility and access to the lower teeth and gums of the canine;
gently pressing the applicator at the gum line of the tooth furthest from the front of the canine's mouth;
moving the applicator using the Lower Rotation to clean each tooth on the second side of the canine's lower jaw; and
stopping application of the treatment gel to the lower teeth on the second side of the canine's mouth after applying the gel to the front upper teeth of the canine.

14. The method of claim 9, wherein the average reduction in bacteria concentration for a mild risk assessment bacteria is approximately 72 percent.

15. The method of claim 9, wherein the average reduction in bacteria concentration for a high risk assessment bacteria is approximately 2 percent.

16. The method of claim 9, wherein the average reduction in bacteria concentration for a severe risk assessment bacteria is approximately 74 percent.
